(19) United States
(12) Patent Application Publication
(10) Pub. No.: US 2006/0031184 A1
(43) Pub. Date: Feb. 9, 2006

(54) Service request module

(76) Inventors: Senthil Kumar Periyaswamy, Karur (IN); Saurabh Kumar, Troy, MI (US); Jan M. Gabriele, Orion, MI (US)

Correspondence Address: STEPHEN R. LOE, THE LAW OFFICE OF STEPHEN R. LOE, P.O. BOX 649, FRISCO, TX, 75034, US

(21) Appl. No.: 10/911,063

(22) Filed: Aug. 4, 2004

(51) Int. Cl. G06F 17/30

(52) U.S. Cl. 707/1

(57) ABSTRACT

A method, system, and computer program product for providing external software applications with access to data elements contained within a database is provided. In one embodiment, a Service Request Module (SRM) receives a request from the external software application for data from the database. The SRM determines whether the requesting application is authorized to access the requested data and, if so, reformulates the request to form a new request, wherein the new request conforms to standards understandable by the database. Once the data is received from the database, the SRM reformats the data into a format desired by the requesting application and transmits the data back to the requesting software application. The present invention, thus allows changes can be made to the database, without requiring that each application that may make calls to the database be edited with new code. Rather, all that needs to be done is to edit a table with Application Program Interface (API) parameters for each application that makes calls to the database.

### BACKGROUND OF THE INVENTION

1. Technical Field

The present invention relates generally to computer software and, more particularly, to databases, and still more particularly, to methods of sharing data.

2. Description of Related Art

One of the key problems with existing database systems is the limitations imposed by these systems in sharing data. Many downstream systems within a business's computing environment as well as external vendors rely on data from this system to support their own system needs and business processes. Often, the data in the system is considered to be a key asset to the business. In order to share data with these applications, in the past, business owners had Application Program Interfaces (APIs) built to provide real-time access to the data. In addition, they also often developed flat file extracts for those systems that only needed the data in a batch mode.

As the business environment and supporting data evolved, the businesses found they were often limited as to how this new data could be provided to these downstream systems and also how quickly it could be provided to them. Changes to existing APIs or system extracts required long development lead times and high costs to implement. Plus, any changes to the existing APIs or extracts severely impacted the current users, so now the only means that the business had to make new data available was to create new APIs or extracts. Many times, due to yearly budget reductions and their reliance on a costly Information Technology (IT) provider, the business would determine that the only alternative they had left were to allow applications to directly access their database tables and to use the data as needed. Such a solution pushes the burden of costs to the downstream systems and reduces a business's costs, however, the business is still faced with the inability to change the underlying data model and structure since it was now exposed to external systems.

Therefore, it would be desirable to have a new common data sharing method that will provide flexibility in allowing new data elements to be incorporated as the business evolves and that make data elements available according to the security level of the requesting application. Furthermore, it would be desirable to have a common data sharing method that provides “Self-Service” capability (i.e., if new data elements are added to support the business, then, this data should be available through the common data sharing method with little or no operational support team required). Additionally, it would be desirable to have a common data sharing method that reduces or eliminates reliance upon an IT provider to intervene when changes to data requirements are required in order to support the business.

### SUMMARY OF THE INVENTION

The present invention provides a method, system, and computer program product for providing external software applications with access to data elements contained within a database. In one embodiment, a Service Request Module (SRM) receives a request from the external software application for data from the database. The SRM determines whether the requesting application is authorized to access the requested data and, if so, reformulates the request to form a new request, wherein the new request conforms to standards understandable by the database. Once the data is received from the database, the SRM reformats the data into a format desired by the requesting application and transmits the data back to the requesting software application. The present invention, thus allows changes can be made to the database, without requiring that each application that may make calls to the database be edited with new code. Rather, all that needs to be done is to edit a table with Application Program Interface (API) parameters for each application that makes calls to the database.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 depicts a block diagram of a data processing system which may be implemented as a server is depicted in accordance with the present invention;

FIG. 3 depicts a block diagram of a data processing system in which the present invention may be implemented;

FIG. 4 depicts a block diagram illustrating an exemplary Service Request Module (SRM) in accordance with one embodiment of the present invention;

FIG. 5 depicts a diagram illustrating an exemplary program function and process flow executed by the integration software product using the data in the SRM data store in accordance with one embodiment of the present invention;

FIG. 6 depicts a block diagram illustrating an exemplary implementation of the SRM in a third party integration product in accordance with one embodiment of the present invention; and

FIG. 7 depicts a diagram illustrating an exemplary user interface for managing an SRM in accordance with one embodiment of the present invention.

### DETAILED DESCRIPTION OF THE PREFERRED EMBODIMENT

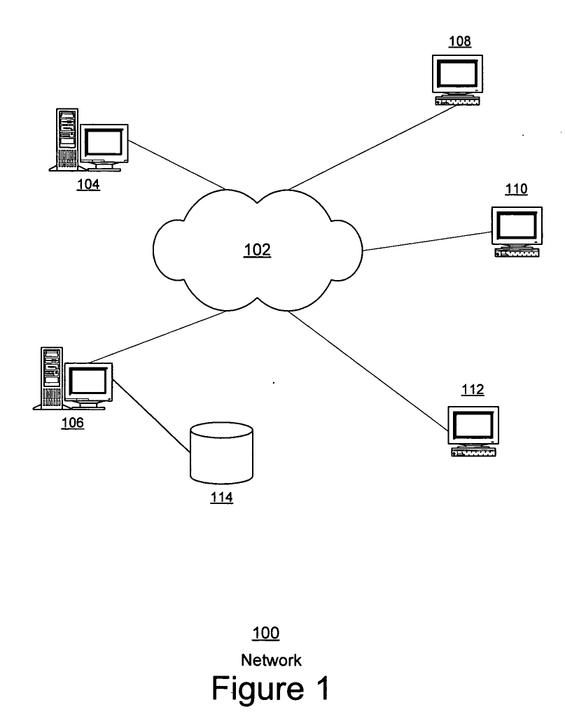

With reference now to the figures, and in particular with reference to FIG. 1, a pictorial representation of a distributed data processing system is depicted in which the present invention may be implemented.

Distributed data processing system 100 is a network of computers in which the present invention may be implemented. Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

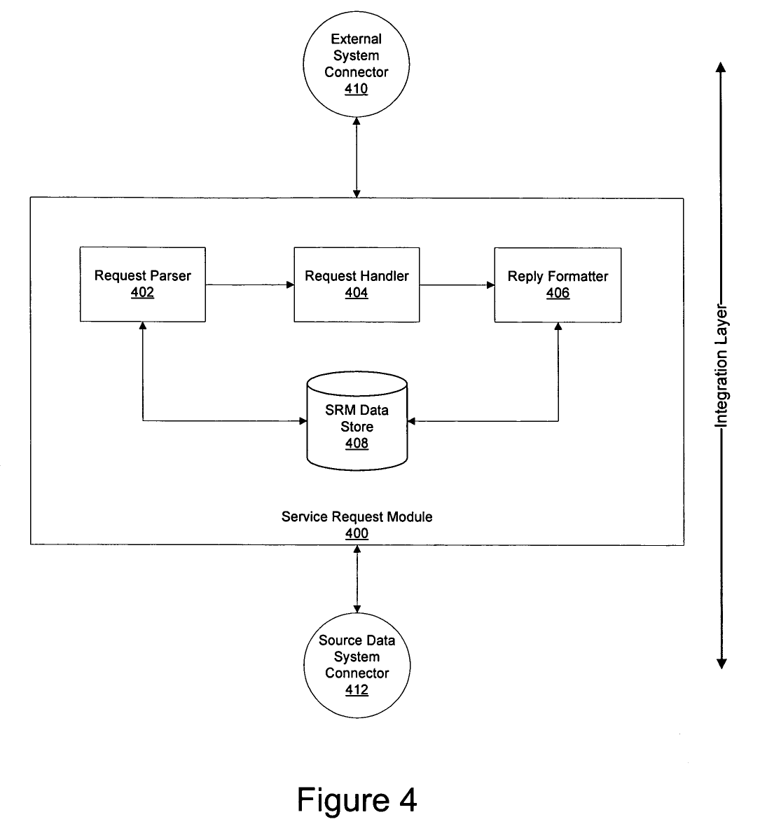

In the depicted example, servers 104 and 106 are connected to network 102. Storage unit 114 is connected to server 106 and contains a database that may be accessed by systems supported by server 106 as well as downstream systems and processes, such as, for example, those provided by server 104. A Service Request Module (SRM) is implemented on server 106 to make data elements to downstream systems, such as, for example, server 104, available according to the security level of the requesting application and provides “Self-Service” capability (i.e., when new data elements are added to support the business, the data is available through the common data sharing method with little or no operational support team required) with reduced or eliminated reliance upon an IT provider to intervene when changes to data requirements are required in order to support the business operating the database on storage unit 114 and the business's downstream business partners, suppliers, clients, and consumers. Thus, business data is exposed to the SRM which provides a robust and flexible mechanism for defining business data into a series of Application Program Interfaces (APIs), capturing all of the security, request, reply, and formatting information, etc. . . . about those APIs, and then defines a standard process to access this information within the organized structure of the SRM. The SRM and its processes are described in more detail below with reference to FIGS. 4-7.

In addition, clients 108, 110 and 112 are also connected to network 102. These clients, 108, 110 and 112, may be, for example, personal computers or network computers. In the depicted example, server 106 may provides data from a database located on storage unit 114, to clients 108-112.

Distributed data processing system 100 may include additional servers, clients, and other devices not shown. In the depicted example, distributed data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 100 also may be implemented as a number of different types of networks such as, for example, an intranet or a local area network.

FIG. 1 is intended as an example and not as an architectural limitation for the processes of the present invention.

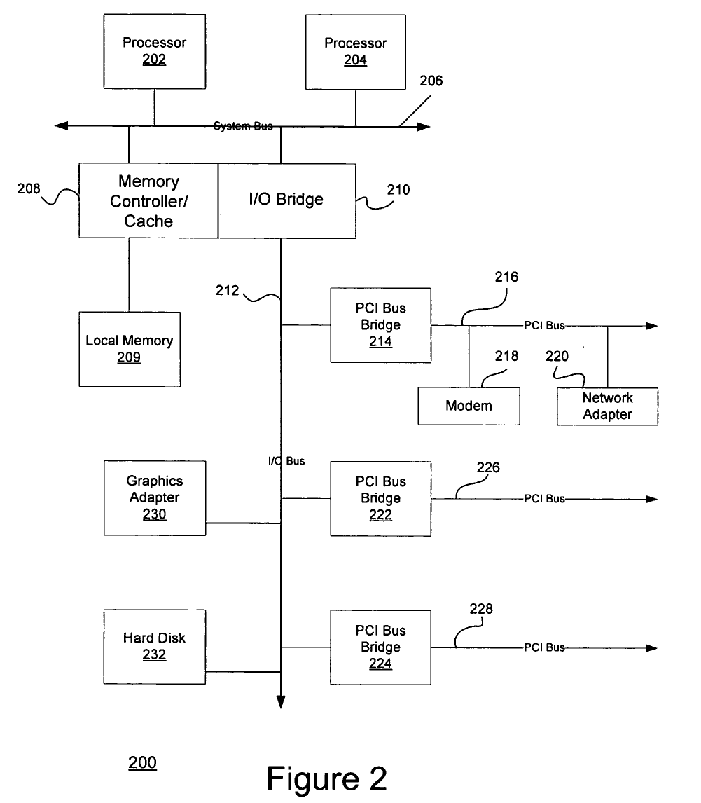

Referring to FIG. 2, a block diagram of a data processing system which may be implemented as a server, such as server 104 or 106 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

Data processing system 200 may be implemented as, for example, an AlphaServer GS1280 running a UNIX® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries

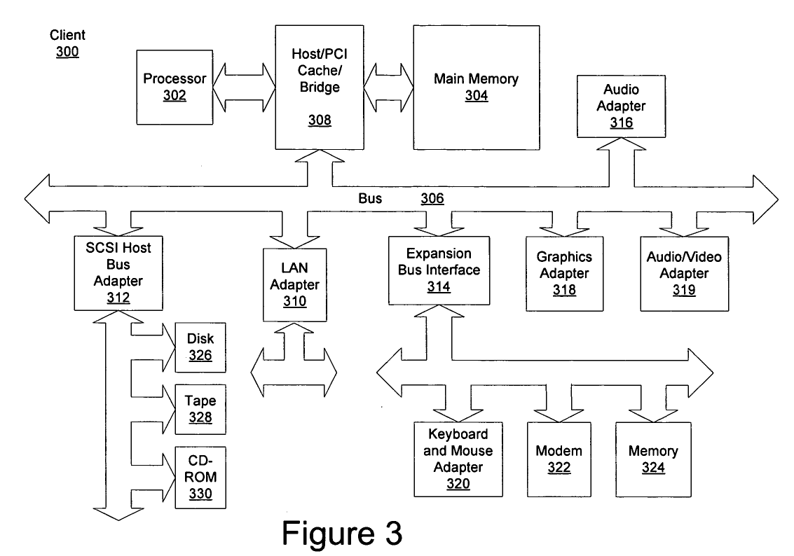

With reference now to FIG. 3, a block diagram of a data processing system in which the present invention may be implemented is illustrated. Data processing system 300 is an example of a client computer. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation of Redmond, Wash. “Windows XP” is a trademark of Microsoft Corporation. An object oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

With reference now to FIG. 4, a block diagram illustrating an exemplary Service Request Module (SRM) is depicted in accordance with one embodiment of the present invention. SRM 400 may be implemented in, for example, server 106 depicted in FIG. 1. Business data is exposed to the SRM which provides a robust and flexible mechanism for defining business data into a series of Application Program Interfaces (APIs), capturing all of the security, request, reply, and formatting information, etc. . . . about those APIs, and then defines a standard process to access this information within the organized structure of the SRM.

The SRM 400, in one embodiment, is executed through an integration layer, using any third party integration software. The integration software is used to process the request/reply communication between the external systems and source data systems. The SRM 400 includes a Request Parser 402, a Request Handler 404, a Reply Formatter 406, and an SRM Data Store 408. The SRM 400 receives API requests from external systems through an external system connector 410 and parses the request with Request Parser 402 to determine what is requested. The SRM 400 then, using the API information in the SRM data store 408, executes the pre-defined SRM process in the Request Handler 404 to frame the query, retrieve the data from the source via a Source Data System Connector 412, format it using Reply Formatter 406, and return the resulting data in the reply back to the application via External System Connector 410.

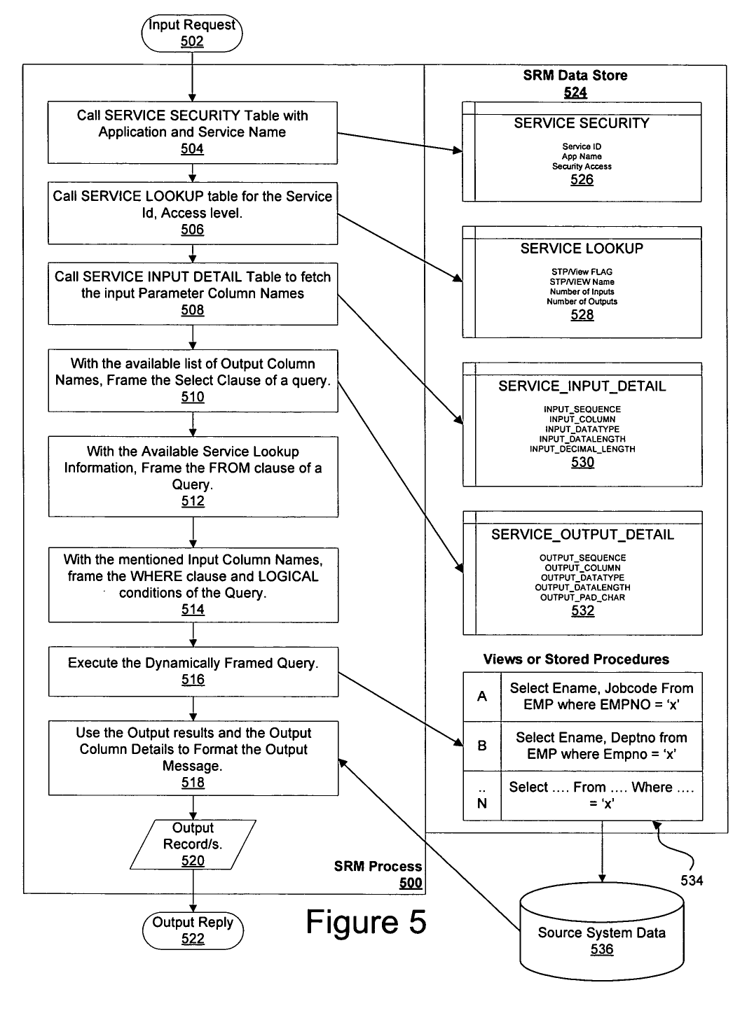

Referring now to FIG. 5, a diagram illustrating an exemplary program function and process flow executed by the integration software product using the data in the SRM data store is depicted in accordance with one embodiment of the present invention. The SRM process depicted in FIG. 5, may be implemented with, for example, SRM 400 depicted in FIG. 4. The SRM process 500 starts when the integration software product receives and API Input request from an external application (step 502). With the information found in the API, the integration software product makes a call to the SERVICE SECURITY table 526 in the SRM Data Store 524 with the Application and Service Name (step 504). The integration software product then makes a call to the SERVICE LOOKUP table 528 for the Service ID and Access level (step 506). The integration software then makes a call to the SERVICE INPUT DETAIL Table 530 to fetch the Input Parameter Column Names (step 508). From there it makes a call to the SERVICE OUTPUT DETAIL Table 532 to fetch the Output Column Names/Output Format Details (step 510). Using the available list of Output Column Names, it frames the Select Clause of a query (step 510).

Using the available Service Lookup Information it then frames the FROM clause of a Query (step 512). Using the Input Column Names, it frames the WHERE clause and LOGICAL conditions of the Query (step 514). Then it executes the Dynamically Framed Query (step 516) to Views or Stored Procedures 534 to access the source system data 536. The integration software product then uses the Output results and the Output Column Details from the Source System Data 536 to Format the Output Message (step 518). The result of this process is a set of Output Records 520 from the request made by the external application. The last step that the integration software does is to provide the Output records in a Reply back to the external application (step 522)

The first aspect of creating the SRM data store, such as, for example, SRM data store 524, is to define a set of APIs to support the business needs of the downstream using applications. In one example, the initial APIs are designed around the data subject areas in of a business data model. Each subject area, for example, provides a view of information about a dealer. Within each subject area, there could be multiple APIs created to support different input types from requesting applications. Once defined, the downstream applications submit their requests with a set of standard inputs that are available for each API and results are returned with a standard set of output data for each subject area. The following include a few examples of subject areas that may be defined:
Address
Address Detail
Business Associate Telephone
Business Associate Activity
Business Associate and Selling Source, Global Business Associate
Business Associate A Department; Hours and Email
Business Associate Electronic Communication System (Email, etc)

The subject area APIs contain the following information:
SQL View
Security levels for the data within the view
Service Lookup information—number of inputs and outputs
Input detail—query select criteria
Output detail—fields provided in the output

Access to business data, is usually defined by the business owner and the external application's need or use of that data. Once these levels are defined, applications will only be allowed use of those APIs and data elements for which they have been authorized. This information is managed within the SRM.

To support the set of APIs within the subject areas, a set of tables have been designed that define the values for accessing the API request. These tables support all of the information required for the APIs, plus the information required to form the dynamic query within the SRM. Once the information is entered into the tables, a database view or stored procedure is built that contains the complex logic for retrieving the data from the database.

The four tables used by the service module as illustrated in FIG. 5 are:
1. SERVICE_SECURITY 526
2. SERVICE_LOOKUP 528
3. SERVICE INPUT_DETAIL 530
4. SERVICE_OUTPUT_DETAIL 532
   The Definition and Layout of the four tables are as follows.
   TABLE NAME: SERVICE SECURITY

This table 526 contains the information about the security access level assigned to each Application for any given Service ID (API number assigned to a Data Subject area). As previously mentioned, the business is responsible for assigning security levels to all of their data elements. There can be multiple levels of access provided to any given Service ID or subject area. Each access level determines what fields will be available in the SRM output provided to that application. If the given application is not authorized to access any particular Service ID, then there will be no entry against that application for that Service ID. The Service ID & Application ID together constitutes a composite primary key. The IO_FORMAT_NBR is applicable in case of fixed length Inputs/Outputs and determines the formatting style of the Input/Output to be picked up from the SERVICE_INPUT_DETAIL 530 & SERVICE_OUTPUT_DETAIL 532 table.

| Column Name | Data Type |
|---|---|
| SERVICE_ID (PK) | Varchar2 |
| | (10) |
| APPLICATION_ID | Varchar2 (15) |
| (PK) | |
| ACCESS_LEVEL | Char (1) |
| IO_FORMAT_NBR | Number (2) |

APPLICTION_ID—Default Value=“ALL”
TABLE NAME: SERVICE LOOKUP

This table 528 defines the number of inputs & number of output columns for any given Service ID and Access level combination. This table 528 also defines the View name or Stored Procedure Name for any Service ID and also an indicator flag, which identifies whether a View or Stored Procedure services it. The Service ID & Application ID together constitutes a composite primary key.

| Column Name | Data Type |
|---|---|
| SERVICE_ID (PK) | Varchar2 |
| | (10) |
| ACCESS_LEVEL (PK) | Char (1) |
| STP_VIEW_FLAG | Char (1) |
| STP_VIEW_NAME | Varchar2 (20) |
| NO_OF_INPUTS | Number (2) |
| NO_OF_OUTPUTS | Number (4) |
| SERVICE_STATUS | Varchar2 (20) |

Table Name: SERVICE INPUT DETAIL

This table 530 provides data to frame the WHERE clause syntax of a Dynamic query. The Input sequence helps to frame the order of the WHERE Clause fields of the query on the view. This column can be used to frame the query to utilize the index search features of the database. The “operational conditions” column holds values like “=”, “< >”, “>”, “<”. The “Logical condition column” holds values like “AND” or “OR”. The INPUT_DATATYPE column determines the data type of the input whether it is a numeric or char. In the case of a Fixed Length type then the INPUT_DATALENGTH column is used to determine the length of the input, which is required to parse the fixed length input. The INPUT_DECIMAL_LENGTH column is used to define the length of the decimal numbers in case of a numeric data type.

| Column Name | Data Type |
|---|---|
| SERVICE_ID (PK) | Varchar2 (10) |
| ACCESS_LEVEL (PK) | Char (1) |
| INPUT_SEQUENCE | Number (2) |
| INPUT_COLUMN | Varchar2 (50) |
| OPERATIONAL_CONDITION | Char (10) |
| LOGICAL_CONDITION | Char (3) |
| IO_FORMAT_NBR | Number (2) |
| INPUT_DATATYPE | Varchar2 (10) |
| INPUT_DATALENGTH | Number (5) |
| INPUT_DECIMAL_LENGTH | Number (3) |

Table Name: SERVICE OUTPUT DETAIL

This table 532 provides data to frame the SELECT list of columns, which is expected to be output as a result of the query. This table 532 also has data about the list of output columns for use in the case of a stored procedure. The OUTPUT_SEQUENCE field determines the order of the OUTPUT_COLUMN in which the output is expected. In the case where the output is of the Fixed length type, the OUTPUT_DATATYPE column determines the data type of the output and whether it is a numeric or char. The OUTPUT_DATALENGTH column determines the length of the output which is required to frame the fixed length output. The OUTPUT_DECIMAL_LENGTH column defines the length of the decimal numbers in case of a numeric data type. The OUTPUT_PAD_FLAG defines if the data is to be LEFT or RIGHT padded and the OUTPUT_PAD_CHAR defines the padding character to be used as the filler.

| Column Name | Data Type |
|---|---|
| SERVICE_ID (PK) | Varchar2 |
| | (10) |
| ACCESS_LEVEL (PK) | Char (1) |
| OUTPUT_SEQUENCE | Number (4) |
| OUTPUT_COLUMN | Varchar2 (50) |
| IO_FORMAT_NBR | Number (2) |
| OUTPUT_DATATYPE | Varchar2 (10) |
| OUTPUT_DATALENGTH | Number (5) |
| OUTPUT_DECIMAL_LENGTH | Number (3) |
| OUTPUT_PAD_FLAG | Char (1) |
| OUTPUT_PAD_CHAR | Char (1) |

Queries to Access SRM Information

The following section provides a set of queries that are used to access the information in the SRM for the solution provided for our customer.

Query to Select the Security Access Level for a Given Service ID for an Application

The query below is performed on the database to get the access level that the application is entitled to for the given service number.

```
SELECT  ACCESS_LEVEL
          IO_FORMAT_NBR
INTO
      :access_level
      :io_format_nbr
FROM
      SERVICE_SECURITY
WHERE
      SERVICE_ID = :input_service_number  AND
      (APPLICATION_ID  = :input_application_id
      OR  APPLICATION_ID = ‘ALL’ )
```

Query to Select the Basic Input/Output Information for a Given Service ID for an Access Level

The below query is performed to find the number of Input & output fields required to perform the query in the database for a given security access level for the targeted service id.

```
Select  STP_VIEW_FLAG,
      STP_VIEW_NAME,
      NO_OF_INPUTS,
      NO_OF_OUTPUTS,
      SERVICE_STATUS
INTO
      :stp_view_flag
      :stp_view_name,
      :no_of_inputs,
      :no_of_outputs,
      :svc_status
FROM
SERVICE_LOOKUP
WHERE
      SERVICE_ID = :input_service_number  AND
      ACCESS_LEVEL = :access_level
```

The STP_VIEW_FLG indicates whether the “Service ID” is provided data by a “View” or a “Stored Procedure”.

The STP_VIEW_NAME indicates the name of the “View” or the “Stored Procedure” that will be used to retrieve data for the Service ID.

The NO_OF_INPUTS indicates the number of columns on which the WHERE clause of a Select query will be applied.

The NO_OF_OUTPUTS indicates the number of output columns which form the SELECT list of the query to be framed on the VIEW or the Output list of a Stored Procedure.

The SERVICE_STATUS indicates the life cycle status of the Service—Emerging, Standard and Deprecated (with supporting end date).

Query to Select the List of Input Columns and the Conditions to be Applied

The below query is performed to obtain the list of INPUT_COLUMNs which form part of the WHERE clause in the dynamic query on a view. These are the columns for which the input parameters are supplied by the calling Application while calling the Service ID.

| | |
|---|---|
| SELECT | INPUT_COLUMN, |
| | OPERATIONAL_CONDITION, |
| | LOGICAL_CONDITION |
| INTO | |
| | :input column[ ], |
| | :operational_condition[ ], |
| | :logical_condition[ ] |
| FROM | |
| | SERVICE_INPUT_DETAIL |
| WHERE | |
| | SERVICE_ID = :input_service_number AND |
| | ACCESS_LEVEL = :access_level |

OERDER BY INPUT_SEQUENCE;

Query to Select the Output Column List

The below query is used to select the list of output columns based on their sequence.

| | |
|---|---|
| SELECT | OUTPUT_COLUMN |
| INTO | |
| | :output_column[ ] |
| FROM | |
| | SERVICE_OUTPUT_DETAIL |
| WHERE | |
| | SERVICE_ID = :input_service_number AND |
| | ACCESS_LEVEL = :access_level |
| ORDER BY | OUTPUT_SEQUENCE; |

Query to Select the Output Column List and Format for the Fixed length Output

| | |
|---|---|
| SELECT | OUTPUT_COLUMN, |
| | OUTPUT_DATATYPE, |
| | OUTPUT_DATALENGTH, |
| | OUTPUT_PAD_FLAG, |
| | OUTPUT_PAD_CHAR |
| INTO | |
| | :output_column[ ], |
| | :output_datatype[ ], |
| | :output_datalength[ ], |
| | :output_pad_flag[ ], |
| | :output_pad_char[ ] |
| FROM | |
| | SERVICE_OUTPUT_DETAIL |
| WHERE | |
| | SERVICE_ID = :input_service_number AND |
| | ACCESS_LEVEL = :access_level AND |
| | IO_FORMAT_NBR = :io_format_nbr |
| ORDER BY | OUTPUT_SEQUENCE; |

Framing the Dynamic Query

The below mentioned Pseudo code explains the sequence of framing the dynamic query to be executed to obtain the necessary data for a Service ID.

```
/*  Find if the SERVICE ID uses a View or Stored
Procedure */
IF :stp_view_flag = “V”
THEN
/*  Frame the SELECT statement with the list of OUTPUT
columns */
/*  dynamic_query_str is the string variable which
will hold the newly framed query syntax as its value.
  The query syntax is framed by concatenating appropriate
values to the string in the correct sequence */
dynamic_query_str = “SELECT”
FOR i = 1 TO :no_of_outputs
    IF i <> :no_of_outputs
    dynamic_query_str = dynamic_query_str ||
output_column[i]|| “ , ”
ELSE
    dynamic_query_str = dynamic_query_str ||
output_column[i]
END IF
END FOR LOOP
/*  framing the FROM and WHERE clause , the
input_parameter array values are the ones provided by
the calling Application. the input_column array values
are obtained by the select query mentioned earlier */
dynamic_query_str = “ FROM ” || :stp_view_name
IF  :no_of_inputs > 0 THEN
  /*  The WHERE clause is required only if there are input
filters to be applied */
dynamic_query_str = dynamic_query_str || “ WHERE ”
/*  If  OR condition is encountered then Frame syntax as
  AND ( aaaaa = bbbbb
  OR  cccccc = dddddd )
  AND  eeeee = ffffff  */
FOR  i =  1  to  :no_of_inputs
    IF i <> no_of_inputs
      IF logical_condition[i] = ‘OR’
      v_or_flg = ‘Y’
      IF v_brace_flg = ‘N’
        v_open_brace_chr = ‘(‘
        v_close_brace_chr = ‘ ‘
        v_brace_flg = ‘Y’
      ELSE
        v_open_brace_chr = ‘ ‘
      END IF
    ELSE
      IF v_brace_flg = ‘Y’ AND v_or_flg = ‘Y’
        v_open_brace_chr = ‘ ‘
        v_close_brace_chr = ‘ ) ‘
      ELSE
        v_close_brace_chr = ‘ ‘
      END IF
      v_brace_flg = ‘N’
      v_or_flg = ‘N’
    END IF
dynamic_query_str = dynamic_query_str ||
v_open_brace_chr || input_column[i] ||
operational_condition[i] || :input_parameter[i] ||
v_close_brace_chr || :logical_condition[i]
END  FOR  LOOP
END IF /* (no of input > 0) */
ELSE ( if stp_view_flag = “S”)
THEN
/*  The stored procedure syntax if framed as below */
    dynamic_query_str = stp_view_name || “(“
    FOR i = 1 to :no_of_inputs
    IF i  <> no_of_inputs
dynamic_query_str = dynamic_query_str ||
input_parameter[i] || “,”
    ELSE
dynamic_query_str = dynamic_query_str ||
input_parameter[i]
    END IF
    END FOR LOOP
    dynamic_query_str = dynamic_query_str || “)”
END IF
/*  Execute the dynamic query string framed and obtain
the results onto a result set */
EXECUTE dynamic_query_str INTO :result_string
```

The formatting logic can be implemented either in Java at the Collaboration level (i.e., inside a 3^{rd} party integration product) or use the formatting data while framing the oracle query to obtain a formatted output. However, it is better implemented at the Collaboration level.

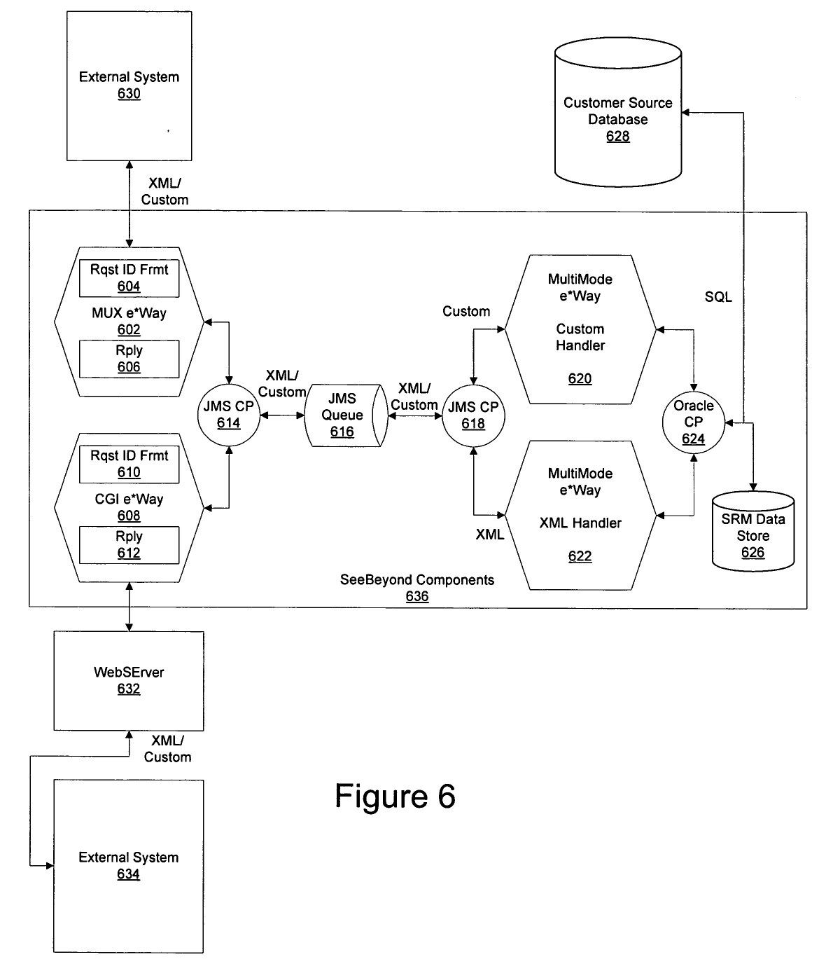

With reference now to FIG. 6, a block diagram illustrating an exemplary implementation of the SRM in a third party integration product is depicted in accordance with one embodiment of the present invention. As previously mentioned, any 3^{rd} party integration software product can be used to implement the Service Request Module. In the example depicted in FIG. 6, SeeBeyond® e*Gate Integrator 4.5* was the integration product used and the components deployed are pictured in the diagram illustrated in FIG. 6. SeeBeyond® e*Gate Integrator 4.5* is a trademark and/or registered trademark as well as a suite of integration products of SeeBeyond Technology Corporation of Monrovia, Calif.

The SeeBeyond components 636 depicted are those that are used to provide the request parsing and reply handling, and those that were deployed to implement the SRM process to query and return the correct data. MUX e*Way 602 is an adapter (communication) program that receives data (request message) sent by an external system 630 using SeeBeyond API-kit client component. MUX e*Way 602 also sends the reply message back to the external system. Rqst ID Formt 604 is a java collaboration (Java program) that runs inside MUX e*Way 602 and processes the request message from the external system 630. Rply 606 is a Java collaboration (Java program) that runs inside the MUX e*Way 602 and processes the reply message to the external system.

CGI e*Way 608 is an adapter (communication) program that enables a variety of external systems to send data to and receive data from SeeBeyond through a web server 632. Rqst ID Formt 610 is a Java collaboration (Java program) that runs inside the CGI e*Way 608 and processes the request message from the external system 630. Rply 612 is a Java collaboration (Java program) that runs inside the CGI e*Way 608 and processes the reply message to the external system. JMS CP 614 is a connection configuration for connecting an e*Way 602 and 608 to the Java Messaging Services (JMS) Queue 616. JMS Queue 616 is a Java messaging services (JMS) based nonvolatile storage (queue) for events/messages within the SeeBeyond system.

JMS CP 618 is a connection configuration for connecting an e*Way to the JMS Queue 616. MultiMode e*Way (Custom Handler) 620 is a flexible and expandable adapter program that can perform transformation/routing functions and communicate with any Java-enabled external system. MultiMode e*Way (XML Handler) 622 is a flexible and expandable adapter program that can perform transformation/routing functions and communicate with any Java-enabled external system. Oracle CP 624 is a connection configuration for connecting a MultiMode e*Way 620 and 622 to a database 626 and 628. SRM Data Store 626 is a database for the Service Request Module. Customer Source Database 628 is a database for the external system 630.

External system 630 may be any external system that sends requests to and receives reply from the SeeBeyond system. Web server 632 is a web server that receives requests from and sends replies to an external system 634. External system 634 may be any external system that sends requests to and receives replies from a web server 632.

These components were depicted in the generic view of the SRM depicted in FIG. 4. The components depicted in FIG. 6 are presented merely as an example of a Service Request Module system and not as an architectural limitation to the present invention. Those skilled in the art will recognize that the components depicted herein may be replaced with other components and that additional components may be added without departing from the scope and spirit of the present invention.

To implement Service Request Module capabilities, it is necessary to define all of the various types of applications that will access the APIs created and the types of formats that will be available to request and receive data. In one example, the SRM supports mainframe and/or non-mainframe based applications and these applications may request data from the SRM interface via a standard XML message structure or a fixed length format message structure. Examples of the request and reply messages are provided below.

XML Service Request Message (XML)—DTD:

| <?xml version=“1.0” encoding=“UTF-8”?> | |
|---|---|
| <!ELEMENT | rqstMsg (svcName, context, parm*)> |
| <!ELEMENT | svcName (#PCDATA)> |
| <!ELEMENT | context EMPTY> |
| <!ATTLIST | context |
| | sourceId CDATA #REQUIRED |
| | userId CDATA #IMPLIED |
| > | |
| <!ELEMENT | parm (#PCDATA)> |
| <!ATTLIST | parm |
| | parmName CDATA #REQUIRED |
| > | |

XML Service Request Message (XML)—An example:

<?xml version=“1.0” encoding=“UTF-8” ?>
- <rqstMsg>
<svcName>ELECOMM001</svcName>
<context sourceId=“ANY_SYS” userId=“ANY_USER” />
<parm parmName=“BUSINESS_ASSOCIATE_CD”>12345</parm>
<parm parmName=“COMMUNICATION_SYSTEM_CD”>001</parm>
</rqstMsg>

XML Service Reply Message (XML)—DTD:

| <?xml version=“1.0” encoding=“UTF-8”?> | |
|---|---|
| <!ELEMENT | replyMsg (rec*, status?)> |
| <!ELEMENT | rec (col*)> |
| <!ELEMENT | col (#PCDATA)> |
| <!ATTLIST | col |
| | colName CDATA #REQUIRED |
| > | |
| <!ELEMENT | status (code?, severity?, description?)> |
| <!ELEMENT | code (#PCDATA)> |
| <!ELEMENT | severity (#PCDATA)> |
| <!ELEMENT | description (#PCDATA)> |

XML Service Reply Message (XML)—An example:

```
<?xml version=“1.0” encoding=“UTF-8” ?>
- <replyMsg>
- <rec>
  <col colName=“BUSINESS_ASSOCIATE_CD”>12345</col>
  <col colName=“COMMUNICATION_SYSTEM_CD”>001</col>
  <col
colName=“COMMUNICATION_SYSTEM_DESC”>EMAIL</col>
  <col colName=“BA_COMNCT_SYS_ID”>ANY_ID</col>
  <col colName=“BA_COMNCT_SYS_ID_SEQ_NBR”>1</col>
  <col
colName=“COMNCT_SYS_ID_USE_CD”>ANY_USE_CD</col>
  <col
colName=“COMNCT_SYS_ID_USE_DESC”>ANY_USE_DESC
</col>
  </rec>
  </replyMsg>
```

Custom Request Message (Fixed Length)

| Data Element | Size/Data | Null/Not |
|---|---|---|
| Name | Type | Null |
| SVC_NAME | CHAR (10) | NOT NULL |
| APPL_ID | CHAR (10) | NOT NULL |
| INPUT_REC (all | Any size | NOT NULL |
| cols | | |
| concatenated) | | |

Custom Reply Message (Fixed length)

| | Size/Data | Null/Not |
|---|---|---|
| Data Element Name | Type | Null |
| OUTPUT_REC_TYPE | CHAR (1) | E = Error, |
| | | “” = Good |
| OUPUT_REC (all | Any size | NOT NULL |
| cols concatenated) | | |

If more than one record then the OUTPUT_REC_TYPE and OUTPUT_REC will repeat after an end-of-line character.

An example of a Custom Request Message:

An example of a Custom Reply Message:

| | | | |
|---|---|---|---|
| ELECOMM001ANY_SYS | 12345 | 001EMAIL | ANY_ID |

Using the formats defined in this method is very valuable because now the business can add new data elements to existing APIs and within the returned data without affecting the downstream applications. Other formats can be also be predefined and stored within the SRM.

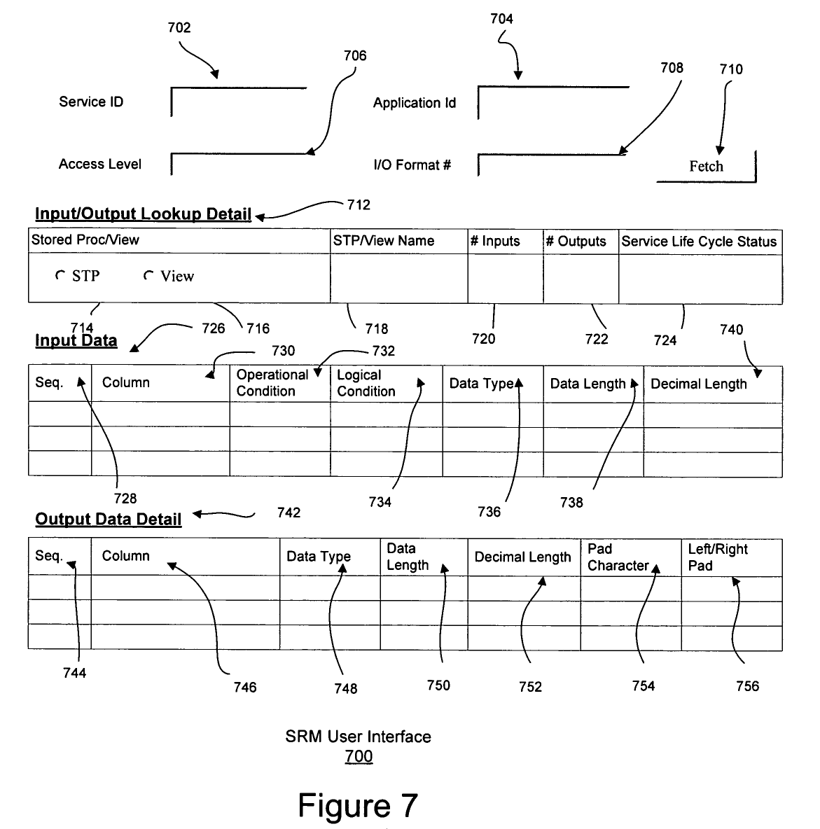

With reference now to FIG. 7, a diagram illustrating an exemplary user interface for managing an SRM is depicted in accordance with one embodiment of the present invention. The SRM information is managed through user interface 700. The business customer can access the SRM components to configure the detailed information required to support the API information. The interface 700 provides data entry blocks 702-708 for allowing a user to input a Service ID 702, an application identification 704, an access level 706, and an Input/Output (I/O) format number 708 for an API to support an application, along with input/output lookup details 712, input data 726, and output data detail 742. The input/output lookup detail 712 provides a bubbles 714 and 716 to indicate whether the a database view or a stored procedure (STP) is built for the application, the name 718 of the STP or Database View, the number of inputs 720, the number of outputs 722, and the service life cycle status 724. The input data 726 provides a table containing the sequence 728, column 730, operational condition 732, logical condition 734, data type 736, data length 738, and decimal length 740 for an API request from this application. The output data detail 742 provides a table indicating the sequence 744, the column 746, the data type 748, and the data length 750, the decimal length 752, the pad character 754, and the left/right pad 756 for the output format for the application. Thus, the information includes:

The API name and numbering
Security levels of the data
Required API input details
API output formats

The business is now able to quickly provide new downstream applications with access to their business data. They are also able to add new data elements into existing APIs, or even create new APIs by entering the data into the SRM tables.

The SRM provides a robust data sharing mechanism because deployment of the integration components becomes a one-time project activity, while the business of sharing the data is now managed within the SRM. The API logic and supporting information is stored in a configurable data store, which eliminates the need to hard code the business logic. Business rule changes can be easily achieved by updating the SRM data store. Applications calling the APIs can use pre-defined data formats such as XML, fixed length or simple delimited. The SRM can additionally be used to wrap a tradition API or web service solution, making it more robust and flexible for the business users.

API information in the SRM data store is now managed by business owners and not an IT staff. This makes data sharing capabilities truly “Self Service”.

The SRM of the present invention provides significant advantages over traditional API solutions. Traditional API solutions involve program level interface, where an application program calls another application (or utility) program with a pre-defined input and output parameters. A change in the input-output parameters causes a change in the calling application program. However, some object oriented programming languages (e.g. java) solve this problem by providing the class reflection mechanism feature where an application program can examine the input-output signatures at run-time. In any case, the traditional API solution is very programming intensive because each API is implemented by coding for a specific business function. Typically when a new API is to be created or an existing API needs a change, the IT department has to get involved to make the necessary change.

In contrast, the SRM of the present invention is a message based interface and not a program level interface. Application programs send request message to the SRM and receive back the reply message from SRM. The business logic for the request-reply service is not hard coded in any API but maintained in the SRM data store in the form of data. Business users can create new API or change an existing API by simply updating the SRM data store using a graphical user interface.

Furthermore, the SRM of the present invention provides significant advantages to a web service design as well. A web service is a self-describing, self-contained, modular unit of application logic that provides some business functionality to other applications through an Internet connection. Applications access web services via ubiquitous web protocols and data formats, such as HTTP and XML, with no need to worry about how each web service is implemented. Web services can be mixed and matched with other web services to execute a larger workflow or business transaction.

UDDI (Universal Description, Discovery and Integration) specification enables businesses to describe its business and its web services and discover other businesses that offer desired web services.

SRM differs from web services because it is not programmatically coded like web services but maintained in the form of data in the SRM data store. Unlike web services which are coded and maintained by an IT department, SRM can be easily maintained by the business users through a graphical user interface. Also, SRM supports standard and non-standard message formats and communication protocols.

SRM data store differs from UDDI specification because, unlike UDDI, the SRM data store stores the business services descriptions and business services logic. Hence, the SRM data store provides business users with the capabilities of creating new business services and modify existing business services without the necessity of having the IT department modify the system.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for providing third parties software applications with access to at least some of the data in a host's database, the method comprising:
receiving a request from a software application for data from a database;
reformulating the request to form a new request, wherein the new request conforms to request standards for the database;
receiving the data from the database; and
transmitting the data to the software application.

2. The method as recited in claim 1, wherein the request is an application program interface request.

3. The method as recited in claim 1, further comprising:
determining whether the software application is permitted to access the data requested.

4. The method as recited in claim 1, further comprising:
prior to transmitting the data, reformatting the data into a format desired by the software application.

5. The method as recited in claim 1, wherein reformulating the request comprises consulting at least one table containing information about at least one of input data format, output data format, and security level for an application program interface.

6. A computer program product in a computer readable media for use in a data processing system for providing third parties software applications with access to at least some of the data in a host's database, the computer program product comprising:
first instructions for receiving a request from a software application for data from a database;
second instructions for reformulating the request to form a new request, wherein the new request conforms to request standards for the database;
third instructions for receiving the data from the database; and
fourth instructions for transmitting the data to the software application.

7. The computer program product as recited in claim 6, wherein the request is an application program interface request.

8. The computer program product as recited in claim 6, further comprising:
fifth instructions for determining whether the software application is permitted to access the data requested.

9. The computer program product as recited in claim 6, further comprising:
sixth instructions for, prior to transmitting the data, reformatting the data in a format desired by the software application.

10. The computer program product as recited in claim 6, wherein reformulating the request comprises consulting at least one table containing information about at least one of input data format, output data format, and security level for an application program interface.

11. A system for providing third parties software applications with access to at least some of the data in a host's database, the system comprising:
first means for receiving a request from a software application for data from a database;
second means for reformulating the request to form a new request, wherein the new request conforms to request standards for the database;
third means for receiving the data from the database; and
fourth means for transmitting the data to the software application.

12. The system as recited in claim 11, wherein the request is an application program interface request.

13. The system as recited in claim 11, further comprising:
fifth means for determining whether the software application is permitted to access the data requested.

14. The system as recited in claim 11, further comprising:
sixth means for, prior to transmitting the data, reformatting the data in a format desired by the software application.

15. The system as recited in claim 11, wherein reformulating the request comprises consulting at least one table containing information about at least one of input data format, output data format, and security level for an application program interface.

16. A service request module for providing access to data in a database to external applications, the service request module comprising:
a request parser that determines the data requested by an external application;
a request handler that reformats the request into a format understandable by the database; and
a reply formatter which, once the data has been retrieved from the database, formats the data in a format desired by the requesting application.
